(19) United States
(12) Patent Application Publication
(10) Pub. No.: US 2007/0186960 A1
(43) Pub. Date: Aug. 16, 2007

(54) Pure water supply system, and cleaning system and cleaning method using pure water

(75) Inventor: Masayoshi Danbata, Tokyo (JP)

Correspondence Address: YOUNG & THOMPSON, 745 SOUTH 23RD STREET, 2ND FLOOR, ARLINGTON, VA, 22202, US

(73) Assignee: ELPIDA MEMORY, INC., TOKYO (JP)

(21) Appl. No.: 11/703,692

(22) Filed: Feb. 8, 2007

(30) Foreign Application Priority Data
Feb. 14, 2006 (JP) 2006-036647
Dec. 11, 2006 (JP) 2006-333322

(51) Int. Cl. B08B 3/00; B08B 3/14; B08B 7/00

(52) U.S. Cl. 134/42; 134/201

(57) ABSTRACT

There is provided a system capable of supplying pure water containing almost no dissolved gas and pure water containing dissolved gas without increasing the amount of pure water manufactured in a volume production semiconductor factory. In the present invention, pure water is supplied using a pure water supply system, which includes: a pure water manufacturing means for manufacturing pure water having a dissolved gas concentration of 0.4 ppm or lower; a first pure water supply means capable of supplying the pure water from the pure water manufacturing means; a dissolving means that is coupled to the pure water manufacturing means via a coupling portion and dissolves gas in the pure water transferred from the pure water manufacturing means via the coupling portion; and a second pure water supply means capable of supplying the pure water in which the gas has been dissolved by the dissolving means.

### BACKGROUND OF THE INVENTION

1. Field of the Invention

The present invention relates to a pure water supply system, and a cleaning system and a cleaning method using the pure water.

2. Description of the Related Art

In semiconductor manufacturing processes, a large amount of pure water is used in cleaning processes. On the other hand, rapid miniaturization of semiconductor devices and wiring patterns is forcing the need for highly purified water to be used in the cleaning processes because particles generated in the cleaning processes reduce product yield. Furthermore, to prevent spontaneous oxide film formation on a silicon wafer, dissolved oxygen is removed from pure water conventionally by N₂ degassing.

However, pure water from which dissolved oxygen has been removed by N₂ degassing contains nitrogen dissolved in the saturated state, so that air bubbles may be generated in wet cleaning. To prevent this, there is the need for removal of entire dissolved gas. In recent years, vacuum degassing has been employed, as disclosed in Japanese Patent Application Laid-Open No. 10-335294. Pure water from which dissolved gas has been removed by vacuum degassing contains gases only in the range of about 0.1 to 0.4 ppm.

Furthermore, higher packing density of semiconductor integrated circuits is forcing the need for pure water with substantially less impurities, such as organic substances, fine particles, bacteria and ions, when used in cleaning processes in manufacturing semiconductor integrated circuit devices.

Semiconductor manufacturing processes include a large number of cleaning processes, such as a cleaning with pure water at room temperature (25° C.) (in some cases, hereinafter referred to as a pure water rinsing), a cleaning with pure water at a temperature of 40 to 70° C. (in some cases, hereinafter referred to as a hot water rinsing), an SPM cleaning with a mixture of sulfuric acid and hydrogen peroxide, and an APM cleaning with a mixture of aqueous ammonia and hydrogen peroxide. In recent years, larger substrate sizes have made it difficult to clean substrates in a cleaning tank, so that a single wafer-type cleaning apparatus has been frequently used. In the single wafer-type cleaning apparatus, the substrate is first rotated at low speed such that a cleaning liquid is supplied and covers the entire surface of the substrate, and then the substrate is rotated at higher speed to remove the cleaning liquid from the substrate. The cleaning is typically performed by repeating this process multiple times.

The cleaning liquid used in the SPM cleaning includes a high concentration of sulfuric acid and hence has high viscosity, so that it takes time to perform the subsequent pure water rinsing in order to remove the sulfuric acid. To address this problem, the SPM cleaning is typically followed by a hot water rinsing at 70° C. On the other hand, when a single wafer-type cleaning apparatus is used, a hot water rinsing has become typical even after the APM cleaning or even in a typical rinsing process.

However, when a substrate having a silicon nitride-type insulating film exposed thereon, such as a silicon nitride film and a silicon oxynitride film, undergoes the SPM cleaning followed by the hot water rinsing at 40° C. or higher with pure water from which dissolved gas has been removed by vacuum degassing, a large number of particles are disadvantageously generated on the substrate, as shown in FIG. 2.

The generation of the particles is caused as follows. The silicon nitride-type insulating film has not only Si and N but also residual O, Cl, NOₓ and the like, which are derived from gaseous components used in the deposition process, and that there include not only Si—N bond but also Si—O bond, the N—N bond and the like on the top surface. On the other hand, more highly purified water becomes higher-level hungry water, thereby exhibiting greater cleaning capability. Thus, when the substrate having the silicon nitride-based insulating film exposed thereon undergoes the SPM cleaning followed by the hot water rinsing at 40° C. or higher with pure water from which dissolved gas has been removed by vacuum degassing, the pure water easily reacts with the residual components present in the unstable layer on the surface of the silicon nitride-type insulating film (such as a silicon nitride film and a silicon oxynitride film), and further reacts with the Si—N bond. Then, the etched silicon nitride-type insulating film generates products. These are considered to contribute to the generation of the particles.

When a substrate having a silicon nitride-based insulating film exposed thereon undergoes a hot water rinsing at 40° C. or higher with pure water from which dissolved gas has been removed by vacuum degassing, it has been confirmed again that a large number of particles are generated on the substrate even after an APM cleaning or even in a hot water rinsing in a typical rinsing process.

FIG. 3 shows the number of particles generated on the substrate having a silicon nitride film exposed thereon, when the substrate underwent a pure water rinsing at 25° C. and a hot water rinsing at 70° C. with pure water having a dissolved gas concentration of 0.4 ppm manufactured by vacuum degassing. In each rinsing operation, the left group shows the number of particles generated when the substrate first underwent the SPM cleaning followed by the rinsing, and the right group shows the number of particles generated when the substrate underwent the rinsing without the SPM cleaning.

In the case of the hot water rinsing at 70° C. with pure water having a dissolved gas concentration of 0.4 ppm or lower, a large number of particles were generated on the surface of the substrate that had undergone the SPM cleaning and on the surface of the substrate without the SPM cleaning. In the case of the pure water rinsing at 25° C., although particles were generated, the number of particles was less than the number that affects semiconductor elements formed on the substrate.

FIG. 4 shows the amount of reduction in film thickness of the silicon nitride film, when the substrate underwent a pure water rinsing at 25° C. and a hot water rinsing at 70° C. with pure water having a dissolved gas concentration of 0.4 ppm manufactured by vacuum degassing. In each rinsing operation, the left group shows the amount of reduction in film thickness of the silicon nitride film when the substrate first underwent the SPM cleaning followed by the rinsing, and the right group shows the amount of reduction in film thickness of the silicon nitride film when the substrate underwent the rinsing without the SPM cleaning.

In the case of the hot water rinsing at 70° C. with pure water having a dissolved gas concentration of 0.4 ppm or lower, the amount of reduction in film thickness of the silicon nitride film was large when the substrate underwent the SPM cleaning and when the substrate did not undergo the SPM cleaning. In the case of the pure water rinsing at 25° C., the amount of reduction in film thickness of the silicon nitride film was small.

It is seen from the above results that the particles generated in the hot water rinsing result from the reduction in film thickness of the silicon nitride film. FIG. 5 shows the relationship between the number of particles generated on the surface of the substrate and the amount of reduction in film thickness (the amount of etching) of the silicon nitride film. As shown in FIG. 5, it is seen that the amount of reduction in film thickness of the silicon nitride film correlates with the number of particles generated on the surface of the substrate.

It is possible to use pure water having a dissolved nitrogen concentration of 16 to 20 ppm manufactured by N₂ degassing in a typical hot water rinsing in order to prevent the generation of particles on the surface of the semiconductor substrate having a silicon nitride-type insulating film exposed thereon. However, in other cleaning processes, it is not possible to prevent generation of air bubbles resulting from the dissolved nitrogen, which may reduce semiconductor manufacturing yield and hence renders this method unusable.

On the other hand, since a large amount of pure water is used in semiconductor processes and lack of pure water in the manufacturing processes will shut the manufacturing line down, an excessive amount of pure water is manufactured in order to prevent the shutdown of the manufacturing line. If pure water is manufactured by vacuum degassing and simultaneously manufactured by N₂ degassing, an appropriate amount of pure water corresponding to the amount of pure water used in each of the processes needs to be manufactured in each degassing method. However, in the semiconductor manufacturing processes in a volume production factory, it is difficult to accurately know the amount of semiconductor substrates that pass each cleaning process, so that a larger amount of pure water needs to be manufactured than conventionally used. The water consumption in the volume production semiconductor factory is equivalent to the amount of water, if measured on an ordinary household basis, consumed by several tens of thousands people. Therefore, it is not preferable to manufacture a large amount of pure water of the two types.

### SUMMARY OF THE INVENTION

An object of the present invention is to provide a system capable of supplying pure water containing almost no dissolved gas and pure water containing dissolved gas without increasing the amount of pure water manufactured in a volume production semiconductor factory.

The present invention provides a pure water supply system, which includes: a pure water manufacturing means for manufacturing pure water having a dissolved gas concentration of 0.4 ppm or lower; a first pure water supply means capable of supplying the pure water from the pure water manufacturing means; a dissolving means that is coupled to the pure water manufacturing means via a coupling portion and dissolves gas in the pure water transferred from the pure water manufacturing means via the coupling portion; and a second pure water supply means capable of supplying the pure water in which the gas has been dissolved by the dissolving mean.

Examples of the gas to be dissolved by the dissolving means include an inert gas or carbon dioxide.

The pure water supply system may further include a temperature adjusting means for adjusting the temperature of the pure water supplied from the second pure water supply means. The temperature adjusting means may be a heating means, which can be provided in any one of the coupling portion, the dissolving means and the second pure water supply means. In this case, the pure water supplied from the second pure water supply means can be adjusted to have a temperature of 40 to 80° C. and a dissolved gas concentration of 4 to 20 ppm.

The present invention also provides a cleaning system, which includes: a pure water manufacturing means for manufacturing pure water having a dissolved gas concentration of 0.4 ppm or lower; a first pure water supply means capable of supplying the pure water from the pure water manufacturing means; a dissolving means that is coupled to the pure water manufacturing means via a coupling portion and dissolves gas in the pure water transferred from the pure water manufacturing means via the coupling portion; a second pure water supply means capable of supplying the pure water in which the gas has been dissolved by the dissolving means; and a cleaning means that is coupled to the first pure water supply means and/or the second pure water supply means and cleans a substrate using the pure water supplied from the first pure water supply means or the second pure water supply means.

Examples of the substrate include a substrate having a silicon nitride film or a silicon oxynitride film exposed thereon.

Examples of the gas to be dissolved by the dissolving means include an inert gas or carbon dioxide.

The cleaning system may further include a temperature adjusting means for adjusting the temperature of the pure water supplied from the second pure water supply means. The temperature adjusting means may be a heating means, which can be provided in any one of the coupling portion, the dissolving means and the second pure water supply means. In this case, the pure water supplied from the second pure water supply means can be adjusted to have a temperature of 40 to 80° C. and a dissolved gas concentration of 4 to 20 ppm.

The cleaning system is suitable for cleaning a substrate, that has undergone SPM cleaning, with the pure water supplied from the second pure water supply means and adjusted to have a temperature of 40 to 80° C. and a dissolved gas concentration of 4 to 20 ppm. The cleaning system is suitable for cleaning a substrate, that has undergone APM cleaning, with the pure water supplied from the first pure water supply means or the second pure water supply means.

The cleaning system may further include a hydrofluoric acid mixing means for mixing hydrofluoric acid into the pure water supplied from the first pure water supply means and/or the second pure water supply means.

The present invention further provides a method for cleaning a substrate, which includes the step of cleaning the substrate with the pure water supplied from the first pure water supply means or the second pure water supply means using the cleaning system.

The cleaning method can be applied, for example, as a cleaning method for cleaning the substrate, that has undergone SPM cleaning, with the pure water supplied from the second pure water supply means. The cleaning method can also be applied as a cleaning method for cleaning the substrate, that has undergone APM cleaning, with the pure water supplied from the first pure water supply means or the second pure water supply means.

The cleaning method can further be applied as a cleaning method for cleaning the substrate with the pure water mixed with hydrofluoric acid that is supplied from the first pure water supply means or the second pure water supply means using the cleaning system which further includes a hydrofluoric acid mixing means for mixing hydrofluoric acid into the pure water supplied from the first pure water supply means and/or the second pure water supply means. The pure water mixed with hydrofluoric acid may be a mixture of 1 part by weight of 55 wt % hydrofluoric acid and 100 to 500 parts by weight of the pure water supplied from the first pure water supply means or the second pure water supply means.

The present invention can provide a system capable of supplying pure water containing almost no dissolved gas and pure water containing dissolved gas from one pure water manufacturing apparatus. That is, the system can prepare, for example, pure water containing almost no dissolved gas used for hot water rinsing on a surface of a substrate having a silicon nitride film or a silicon oxynitride film exposed thereon, or can prepare, for example, pure water containing dissolved gas used for hot water rinsing after an SPM process. As a result, the amount of water manufactured in a volume production semiconductor factory will not increase.

### BRIEF DESCRIPTION OF THE DRAWINGS

FIG. 1 is a schematic diagram showing the configuration of one embodiment of the cleaning system according to the present invention;

FIG. 2 shows particles generated on a substrate;

FIG. 3 shows the number of particles generated on the substrate having a silicon nitride film exposed thereon, when the substrate underwent a pure water rinsing at 25° C. and a hot water rinsing at 70° C. with pure water having a dissolved gas concentration of 0.4 ppm manufactured by vacuum degassing;

FIG. 4 shows the amount of reduction in film thickness of the silicon nitride film, when the substrate underwent a pure water rinsing at 25° C. and a hot water rinsing at 70° C. with pure water having a dissolved gas concentration of 0.4 ppm manufactured by vacuum degassing; and

FIG. 5 shows the relationship between the number of particles generated on the surface of the substrate and the amount of reduction in film thickness (the amount of etching) of the silicon nitride film.

### DETAILED DESCRIPTION OF THE PREFERRED EMBODIMENT

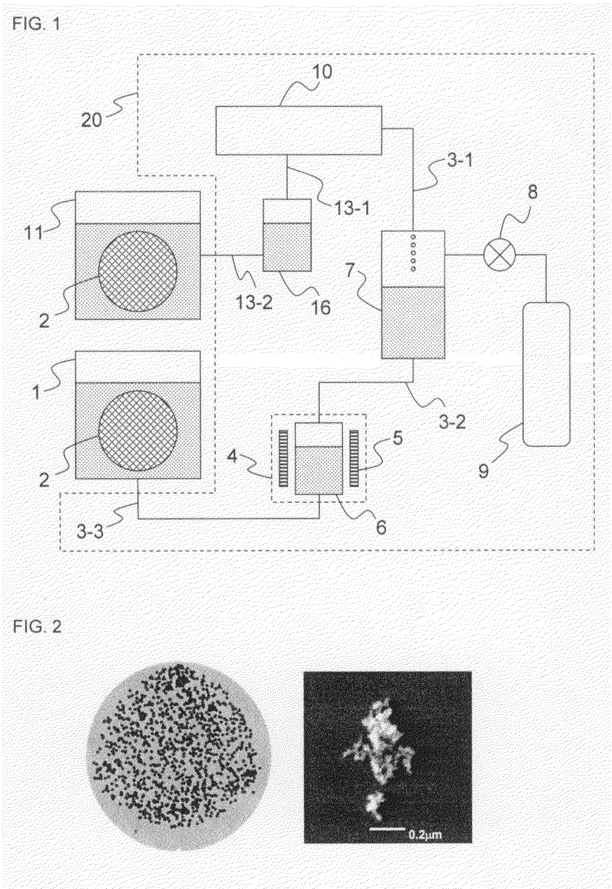

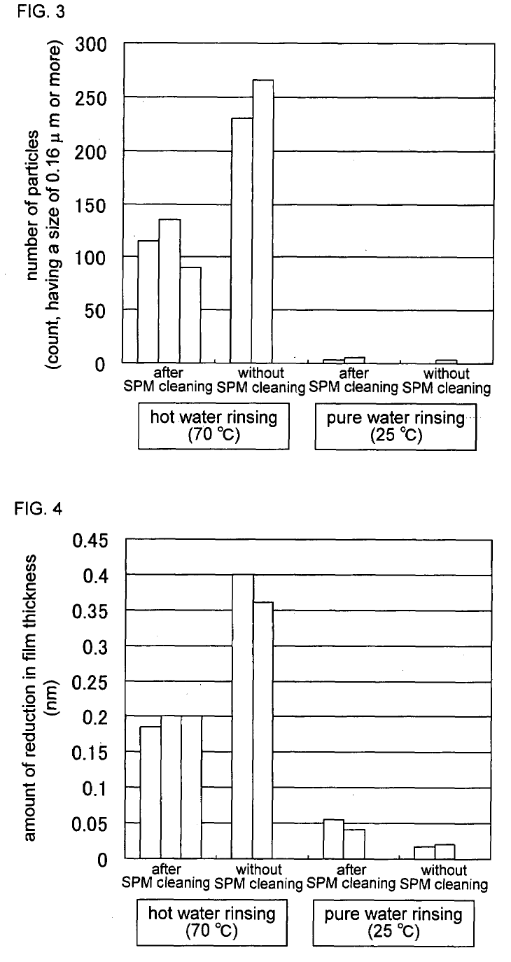

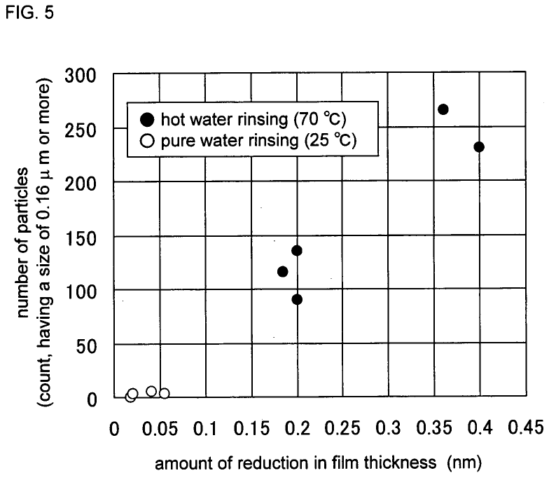

FIG. 1 is a schematic diagram showing the configuration of one embodiment of the cleaning system according to the present invention.

In this cleaning system, the pure water supply system 20 according to the present invention is connected to cleaning tanks 1 and 11, each of which is a cleaning means. The pure water supply system 20 is configured to be able to supply pure water manufactured in a pure water manufacturing apparatus 10, which is a pure water manufacturing means, from a first pure water reservoir 16, which is a first pure water supply means, and a second pure water reservoir 6, which is a second pure water supply means, to the cleaning tanks. The cleaning tanks 1 and 11 may be separately connected to the first pure water reservoir 16 and the second pure water reservoir 6, as shown in the system of FIG. 1, or each of the cleaning tanks may be connected to the two pure water reservoirs. Only one cleaning tank may be provided when the cleaning tank is connected to the two pure water reservoirs.

In the pure water manufacturing apparatus 10, pure water adjusted to have a low dissolved gas concentration of 0.4 ppm or lower under normal pressure (atmospheric pressure) was manufactured by vacuum degassing. The pure water manufactured in the pure water manufacturing apparatus 10 is typically at room temperature (about 25° C.).

The pure water manufacturing apparatus 10 is connected to the first pure water reservoir 16, which is the first pure water supply means, via pipes 13-1 and 13-2. In such a configuration, the pure water manufactured in the pure water manufacturing apparatus 10 can be supplied from the first pure water reservoir 16 to the cleaning tank 11 with the low dissolved gas concentration maintained.

A temperature adjusting means for adjusting the temperature of the pure water supplied from the first pure water reservoir 16 to the cleaning tank 11 may be installed around the first pure water reservoir 16, the pipes 13-1 or 13-2. The temperature adjusting means may be a heating means or a cooling means, which will be described later.

On the other hand, the pure water manufacturing apparatus 10 is also connected to a dissolving apparatus 7, which is a dissolving means, and the second pure water reservoir 6, which is the second pure water supply means, via pipes 3-1, 3-2 and 3-3. The dissolving apparatus 7 is connected to a gas cylinder 9 that stores high-pressure gas via a regulator 8. The gas can be supplied from the gas cylinder 9 at a constant pressure such that a predetermined amount of gas can be dissolved in the pure water manufactured in the pure water manufacturing apparatus 10. Then, the pure water adjusted to have the predetermined dissolved gas concentration can be supplied from the second pure water reservoir 6 to the cleaning tank 1.

Examples of the method for dissolving gas in the pure water in the dissolving apparatus 7 include a dropping method in which pure water is dropped in a sealed container filled with gas and a bubbling method in which gas is supplied to and bubbled in pure water stored in a sealed container. Both methods are preferably performed in the sealed container in order to prevent dissolution of oxygen present in the atmosphere. When the dropping method is used, since a larger surface area of the pure water to be dropped results in a better gas dissolution efficiency, it is preferable to break up the pure water into droplets before the dropping operation. For example, a commercially available spray nozzle can be used to easily break up pure water into droplets. The particle size of the pure water droplets to be dropped is preferably in the range of 5 μm to 2 mm, more preferably 5 to 200 μm. When the bubbling method is used, since the gas is in contact with the surface of the pure water, the pressure of the gas and the temperature of the pure water in the sealed container determine the saturated amount of the gas to be dissolved in the pure water.

Examples of the gas to be dissolved in pure water include inert gases such as nitrogen, argon and helium, and carbon dioxide.

The amount of the gas to be dissolved in the pure water can be adjusted by the internal temperature of the dissolving apparatus 7 and the pressure of the gas to be supplied. The dissolved gas concentration of the resultant pure water is preferably 4 ppm or higher under atmospheric pressure, and is preferably 20 ppm or lower, more preferably 16 ppm or lower, under atmospheric pressure. When the dissolved gas concentration is 4 ppm or higher, a hot water rinsing can be performed without particle generation. When the dissolved gas concentration is 20 ppm or lower, it will be difficult to form air bubbles resulting from the dissolved gas on the substrate, even when the temperature of the hot water is 80° C.

A heater 5, which is a heating means for heating the pure water in the second pure water reservoir 6, is disposed around the second pure water reservoir 6. Therefore, a hot water manufacturing apparatus 4 consisting of the second pure water reservoir 6 and the heater 5 can heat the pure water supplied from the second pure water reservoir 6 to the cleaning tank 1. The heating means is not limited to a heater, but may be another apparatus typically used, such as a heat exchanger.

The temperature of the pure water supplied from the second pure water reservoir 6 to the cleaning tank 1 is preferably 40° C. or higher, and is preferably 80° C. or lower, more preferably 70° C. or lower. When the temperature of the pure water is 40° C. or higher, sulfuric acid can be efficiently removed when the pure water is used for a hot water rinsing after the SPM cleaning. When the temperature of the pure water is 80° C. or lower, air bubbles resulting from the dissolved gas in the pure water will not be formed on the substrate. In consideration of process management, the temperature of the pure water is preferably 70° C. or lower.

When it is necessary to supply pure water at a temperature lower than room temperature, a cooling means may be provided in place of the heating means. Examples of the cooling means include apparatuses typically used, such as an apparatus using a cooling medium and a heat exchanger. When pure water to be supplied can be at room temperature, a configuration without a temperature adjusting means, such as a heating means or a cooling means can be employed. Alternatively, it is also possible to design a system in which a pipe branched from the pipe 3-2 is directly connected to the cleaning tank 1 and pure water at room temperature is supplied by switching the branched portion.

The temperature adjusting means for adjusting the temperature of the pure water supplied from the second pure water reservoir 6 may be provided around the dissolving apparatus 7, or the pipe 3-1, 3-2 or 3-3. Particularly, it is preferably provided at the pipe 3-1, the dissolving apparatus 7 or the second pure water reservoir 6.

Alternatively, it is possible to use a dissolving apparatus having a temperature adjusting capability, corresponding to an apparatus obtained by integrating the dissolving apparatus 7 and the hot water manufacturing apparatus 4 in the system shown in FIG. 1. Because the temperature of the pure water supplied to the cleaning tank 1 may be higher than a desired temperature, it is possible to employ a configuration in which a pure water reservoir with a cooling means is provided in the location along the pipe connected to the cleaning tank 1.

Furthermore, there may be provided a hydrofluoric acid mixing means for mixing hydrofluoric acid into the pure water supplied from the first pure water reservoir 16 and/or the second pure water reservoir 6 to the cleaning tanks. In this way, the substrate can be cleaned with pure water into which hydrofluoric acid is mixed as desired. The hydrofluoric acid mixing means can be provided at any location, for example, at the pipes 3-1, 3-2, 3-3, 13-1 or 13-2, the dissolving apparatus 7, the first pure water reservoir 16 or the second pure water reservoir 6.

Hydrofluoric acid to be mixed may be, for example, 55 wt % hydrofluoric acid (hydrogen fluoride aqueous solution). As for the mixing ratio of hydrofluoric acid to pure water, 1 part by weight of hydrofluoric acid is preferably mixed to 100 to 500 parts by weight of pure water.

Each of the pipes may be replaced with a plurality of pipes disposed in parallel, or may be branched into a plurality of pipes.

The configured system can supply pure water containing almost no dissolved gas and pure water containing dissolved gas to the cleaning tanks as desired. For example, nitrogen-dissolved pure water can be supplied from a pure water manufacturing apparatus used in a volume production semiconductor manufacturing factory only to a cleaning tank used in a process in which hot water is used to clean a semiconductor substrate having a silicon nitride-based insulating film exposed thereon. In this case, the dissolving apparatus can be disposed immediately close to the cleaning tank. Further, the dissolving apparatus only needs to dissolve the gas in a necessary amount of pure water to be supplied to the cleaning tank, allowing use of a compact dissolving apparatus.

The system described above can be used to clean a semiconductor substrate 2 in the cleaning tank with the pure water supplied from the first pure water reservoir 16 or the second pure water reservoir 6. Examples of the semiconductor substrate 2 to be cleaned in the cleaning tank include a substrate having a silicon nitride film or a silicon oxynitride film exposed thereon and such a substrate that has undergone SPM cleaning or APM cleaning.

The cleaning of the substrate that has undergone the SPM cleaning is preferably performed with the pure water supplied from the second pure water reservoir and adjusted to have a temperature of 40 to 80° C. and a dissolved gas concentration of 4 to 20 ppm. The cleaning of the substrate that has undergone the APM cleaning is preferably performed with the pure water at room temperature supplied from the first pure water reservoir or the second pure water reservoir, but may be performed with pure water at a temperature of 40 to 80° C. in order to reduce the cleaning time.

### EXAMPLES

The present invention will be described with reference to examples where a semiconductor substrate having a silicon nitride film formed thereon is cleaned.

### Example 1

Firstly, a semiconductor substrate having a silicon nitride film formed thereon underwent an SPM cleaning. Thereafter, pure water adjusted to have a dissolved nitrogen concentration of 4 ppm and a temperature of 40° C. was used to perform a hot water rinsing on the semiconductor substrate that had undergone the SPM cleaning.

The pure water used in the hot water rinsing was manufactured in the apparatus configured as shown in FIG. 1. Specifically, in the pure water manufacturing apparatus 10, pure water having a dissolved gas concentration of 0.4 ppm was manufactured by vacuum degassing. Then, the pure water was transferred to the dissolving apparatus 7 connected to the high-pressure nitrogen cylinder so as to manufacture the pure water having a dissolved nitrogen concentration of 4 ppm. Thereafter, the pure water was heated by the heater 5 of the hot water manufacturing apparatus 4 to 40° C. and supplied to the cleaning tank 1.

### Example 2

Firstly, a semiconductor substrate having a silicon nitride film formed thereon underwent an SPM cleaning. Thereafter, as in the method of Example 1, pure water adjusted to have a dissolved nitrogen concentration of 16 ppm and a temperature of 40° C. was used to perform a hot water rinsing on the semiconductor substrate that had undergone the SPM cleaning.

### Example 3

Firstly, a semiconductor substrate having a silicon nitride film formed thereon underwent an SPM cleaning. Thereafter, as in the method of Example 1, pure water adjusted to have a dissolved nitrogen concentration of 4 ppm and a temperature of 70° C. was used to perform a hot water rinsing on the semiconductor substrate that had undergone the SPM cleaning.

### Example 4

Firstly, a semiconductor substrate having a silicon nitride film formed thereon underwent an SPM cleaning. Thereafter, as in the method of Example 1, pure water adjusted to have a dissolved nitrogen concentration of 16 ppm and a temperature of 70° C. was used to perform a hot water rinsing on the semiconductor substrate that had undergone the SPM cleaning.

### Example 5

Firstly, a semiconductor substrate having a silicon nitride film formed thereon underwent an SPM cleaning. Thereafter, as in the method of Example 1, pure water adjusted to have a dissolved nitrogen concentration of 20 ppm and a temperature of 70° C. was used to perform a hot water rinsing on the semiconductor substrate that had undergone the SPM cleaning.

### Example 6

Firstly, a semiconductor substrate having a silicon nitride film formed thereon underwent an APM cleaning. Thereafter, as in the method of Example 1, pure water adjusted to have a dissolved nitrogen concentration of 4 ppm and a temperature of 70° C. was used to perform a hot water rinsing on the semiconductor substrate that had undergone the APM cleaning.

### Example 7

Firstly, a semiconductor substrate having a silicon nitride film formed thereon underwent an APM cleaning. Thereafter, as in the method of Example 1, pure water adjusted to have a dissolved nitrogen concentration of 16 ppm and a temperature of 70° C. was used to perform a hot water rinsing on the semiconductor substrate that had undergone the APM cleaning.

### Example 8

Firstly, a semiconductor substrate having a silicon nitride film formed thereon underwent an APM cleaning. Thereafter, as in the method of Example 1, pure water adjusted to have a dissolved nitrogen concentration of 20 ppm and a temperature of 70° C. was used to perform a hot water rinsing on the semiconductor substrate that had undergone the APM cleaning.

### Example 9

As in the method of Example 1, pure water adjusted to have a dissolved nitrogen concentration of 4 ppm and a temperature of 70° C. was used to perform a hot water rinsing on a semiconductor substrate having a silicon nitride film formed thereon.

### Example 10

As in the method of Example 1, pure water adjusted to have a dissolved nitrogen concentration of 16 ppm and a temperature of 70° C. was used to perform a hot water rinsing on a semiconductor substrate having a silicon nitride film formed thereon.

### Example 11

As in the method of Example 1, pure water adjusted to have a dissolved nitrogen concentration of 20 ppm and a temperature of 70° C. was used to perform a hot water rinsing on a semiconductor substrate having a silicon nitride film formed thereon.

### Example 12

Firstly, a semiconductor substrate having a silicon nitride film formed thereon underwent an SPM cleaning. Thereafter, diluted hydrofluoric acid (DHF), which was made by mixing 1 part by weight of 55 wt % hydrofluoric acid with 100 parts by weight of pure water and was adjusted to have a dissolved gas concentration of 0.4 ppm and a temperature of 25° C., was used to perform a cleaning on the semiconductor substrate that had undergone the SPM cleaning. Further, pure water adjusted to have a dissolved gas concentration of 0.4 ppm and a temperature of 25° C. was used to perform a rinsing on the semiconductor substrate that had undergone the diluted hydrofluoric acid cleaning.

The diluted hydrofluoric acid used in the cleaning was manufactured in an apparatus having the configuration shown in FIG. 1 and further equipped with a hydrofluoric acid mixing means in the location along the pipe 13-1. Specifically, in the pure water manufacturing apparatus 10, pure water having a dissolved gas concentration of 0.4 ppm was manufactured by vacuum degassing. Then, in process of transferring the pure to the first pure water reservoir 16, the hydrofluoric acid mixing means was used to mix 55 wt % hydrofluoric acid into the pure water. Thereafter, the resultant diluted hydrofluoric acid was supplied to the cleaning tank 11.

### Example 13

Firstly, a semiconductor substrate having a silicon nitride film formed thereon underwent an SPM cleaning. Thereafter, as in the method of Example 12, diluted hydrofluoric acid (DHF), which was made by mixing 1 part by weight of 55 wt % hydrofluoric acid with 500 parts by weight of pure water and was adjusted to have a dissolved gas concentration of 0.4 ppm and a temperature of 25° C., was used to perform a cleaning on the semiconductor substrate that had undergone the SPM cleaning. Further, pure water adjusted to have a dissolved gas concentration of 0.4 ppm and a temperature of 25° C. was used to perform a rinsing on the semiconductor substrate that had undergone the diluted hydrofluoric acid cleaning.

### Example 14

Firstly, a semiconductor substrate having a silicon nitride film formed thereon underwent an SPM cleaning. Thereafter, diluted hydrofluoric acid (DHF), which was made by mixing 1 part by weight of 55 wt % hydrofluoric acid with 100 parts by weight of pure water and was adjusted to have a dissolved nitrogen concentration of 4 ppm and a temperature of 25° C., was used to perform a cleaning on the semiconductor substrate that had undergone the SPM cleaning. Further, pure water adjusted to have a dissolved nitrogen concentration of 4 ppm and a temperature of 25° C. was used to perform a rinsing on the semiconductor substrate that had undergone the diluted hydrofluoric acid cleaning.

The diluted hydrofluoric acid used in the cleaning was manufactured in an apparatus having the configuration shown in FIG. 1 and further equipped with a hydrofluoric acid mixing means in the location along the pipe 3-1. Specifically, in the pure water manufacturing apparatus 10, pure water having a dissolved gas concentration of 0.4 ppm was manufactured by vacuum degassing. Then, in process of transferring the pure to the dissolving apparatus 7 connected to the high-pressure nitrogen cylinder, the hydrofluoric acid mixing means was used to mix 55 wt % hydrofluoric acid into the pure water. Thereafter, as in the method of Example 1, the dissolved nitrogen concentration was adjusted to 4 ppm. Then, the resultant diluted hydrofluoric acid was supplied to the cleaning tank 1.

### Example 15

Firstly, a semiconductor substrate having a silicon nitride film formed thereon underwent an SPM cleaning. Thereafter, as in the method of Example 14, diluted hydrofluoric acid (DHF), which was made by mixing 1 part by weight of 55 wt % hydrofluoric acid with 500 parts by weight of pure water and was adjusted to have a dissolved nitrogen concentration of 16 ppm and a temperature of 25° C., was used to perform a cleaning on the semiconductor substrate that had undergone the SPM cleaning. Further, pure water adjusted to have a dissolved nitrogen concentration of 16 ppm and a temperature of 25° C. was used to perform a rinsing on the semiconductor substrate that had undergone the diluted hydrofluoric acid cleaning.

### Example 16

Firstly, a semiconductor substrate having a silicon nitride film formed thereon underwent an APM cleaning. Thereafter, as in the method of Example 12, diluted hydrofluoric acid (DHF), which was made by mixing 1 part by weight of 55 wt % hydrofluoric acid with 100 parts by weight of pure water and was adjusted to have a dissolved gas concentration of 0.4 ppm and a temperature of 25° C., was used to perform a cleaning on the semiconductor substrate that had undergone the APM cleaning. Further, pure water adjusted to have a dissolved gas concentration of 0.4 ppm and a temperature of 25° C. was used to perform a rinsing on the semiconductor substrate that had undergone the diluted hydrofluoric acid cleaning.

### Example 17

Firstly, a semiconductor substrate having a silicon nitride film formed thereon underwent an APM cleaning. Thereafter, as in the method of Example 12, diluted hydrofluoric acid (DHF), which was made by mixing 1 part by weight of 55 wt % hydrofluoric acid with 500 parts by weight of pure water and was adjusted to have a dissolved gas concentration of 0.4 ppm and a temperature of 25° C., was used to perform a cleaning on the semiconductor substrate that had undergone the APM cleaning. Further, pure water adjusted to have a dissolved gas concentration of 0.4 ppm and a temperature of 25° C. was used to perform a rinsing on the semiconductor substrate that had undergone the diluted hydrofluoric acid cleaning.

### Example 18

Firstly, a semiconductor substrate having a silicon nitride film formed thereon underwent an APM cleaning. Thereafter, as in the method of Example 14, diluted hydrofluoric acid (DHF), which was made by mixing 1 part by weight of 55 wt % hydrofluoric acid with 100 parts by weight of pure water and was adjusted to have a dissolved nitrogen concentration of 4 ppm and a temperature of 25° C., was used to perform a cleaning on the semiconductor substrate that had undergone the APM cleaning. Further, pure water adjusted to have a dissolved nitrogen concentration of 4 ppm and a temperature of 25° C. was used to perform a rinsing on the semiconductor substrate that had undergone the diluted hydrofluoric acid cleaning.

### Example 19

Firstly, a semiconductor substrate having a silicon nitride film formed thereon underwent an APM cleaning. Thereafter, as in the method of Example 14, diluted hydrofluoric acid (DHF), which was made by mixing 1 part by weight of 55 wt % hydrofluoric acid with 500 parts by weight of pure water and was adjusted to have a dissolved nitrogen concentration of 16 ppm and a temperature of 25° C., was used to perform a cleaning on the semiconductor substrate that had undergone the APM cleaning. Further, pure water adjusted to have a dissolved nitrogen concentration of 16 ppm and a temperature of 25° C. was used to perform a rinsing on the semiconductor substrate that had undergone the diluted hydrofluoric acid cleaning.

### Example 20

As in the method of Example 12, diluted hydrofluoric acid (DHF), which was made by mixing 1 part by weight of 55 wt % hydrofluoric acid with 100 parts by weight of pure water and was adjusted to have a dissolved gas concentration of 0.4 ppm and a temperature of 25° C., was used to perform a cleaning on a semiconductor substrate having silicon nitride film formed thereon. Further, pure water adjusted to have a dissolved gas concentration of 0.4 ppm and a temperature of 25° C. was used to perform a rinsing on the semiconductor substrate that had undergone the diluted hydrofluoric acid cleaning.

### Example 21

As in the method of Example 12, diluted hydrofluoric acid (DHF), which was made by mixing 1 part by weight of 55 wt % hydrofluoric acid with 500 parts by weight of pure water and was adjusted to have a dissolved gas concentration of 0.4 ppm and a temperature of 25° C., was used to perform a cleaning on a semiconductor substrate having silicon nitride film formed thereon. Further, pure water adjusted to have a dissolved gas concentration of 0.4 ppm and a temperature of 25° C. was used to perform a rinsing on the semiconductor substrate that had undergone the diluted hydrofluoric acid cleaning.

### Example 22

As in the method of Example 14, diluted hydrofluoric acid (DHF), which was made by mixing 1 part by weight of 55 wt % hydrofluoric acid with 100 parts by weight of pure water and was adjusted to have a dissolved nitrogen concentration of 4 ppm and a temperature of 25° C., was used to perform a cleaning on a semiconductor substrate having silicon nitride film formed thereon. Further, pure water adjusted to have a dissolved nitrogen concentration of 4 ppm and a temperature of 25° C. was used to perform a rinsing on the semiconductor substrate that had undergone the diluted hydrofluoric acid cleaning.

### Example 23

As in the method of Example 14, diluted hydrofluoric acid (DHF), which was made by mixing 1 part by weight of 55 wt % hydrofluoric acid with 500 parts by weight of pure water and was adjusted to have a dissolved nitrogen concentration of 16 ppm and a temperature of 25° C., was used to perform a cleaning on a semiconductor substrate having silicon nitride film formed thereon. Further, pure water adjusted to have a dissolved nitrogen concentration of 16 ppm and a temperature of 25° C. was used to perform a rinsing on the semiconductor substrate that had undergone the diluted hydrofluoric acid cleaning.

### Reference Example 1

Firstly, a semiconductor substrate having a silicon nitride film formed thereon underwent an SPM cleaning. Thereafter, pure water (dissolved gas concentration: 0.4 ppm) adjusted to have a temperature of 40° C. was used to perform a hot water rinsing on the semiconductor substrate that has undergone the SPM cleaning.

The pure water used in the hot water rinsing was manufactured in an apparatus having the configuration shown in FIG. 1 and further equipped with a heater in the first pure water reservoir 16. Specifically, in the pure water manufacturing apparatus 10, pure water having a dissolved gas concentration of 0.4 ppm was manufactured by vacuum degassing. Then, the pure water was transferred to the first pure water reservoir 16. Thereafter, the pure water was heated by the heater in the first pure water reservoir 16 to 40° C., and then supplied to the cleaning tank 11.

### Reference Example 2

Firstly, a semiconductor substrate having a silicon nitride film formed thereon underwent an SPM cleaning. Thereafter, as in the method of Example 1, pure water (temperature: 25° C.) adjusted to have a dissolved nitrogen concentration of 16 ppm was used without being heated to perform a pure water rinsing on the semiconductor substrate that had undergone the SPM cleaning.

### Reference Example 3

Firstly, a semiconductor substrate having a silicon nitride film formed thereon underwent an SPM cleaning. Thereafter, pure water (temperature: 25° C.) manufactured in the pure water manufacturing apparatus 10 and having a dissolved gas concentration of 0.4 ppm was used as it was to perform a pure water rinsing on the semiconductor substrate that had undergone the SPM cleaning.

### Reference Example 4

Firstly, a semiconductor substrate having a silicon nitride film formed thereon underwent an APM cleaning. Thereafter, as in the method of Reference Example 1, pure water (dissolved gas concentration: 0.4 ppm) adjusted to have a temperature of 40° C. was used to perform a hot water rinsing on the semiconductor substrate that has undergone the APM cleaning.

### Reference Example 5

Firstly, a semiconductor substrate having a silicon nitride film formed thereon underwent an APM cleaning. Thereafter, as in the method of Example 1, pure water (temperature: 25° C.) adjusted to have a dissolved nitrogen concentration of 16 ppm was used without being heated to perform a pure water rinsing on the semiconductor substrate that had undergone the APM cleaning.

### Reference Example 6

Firstly, a semiconductor substrate having a silicon nitride film formed thereon underwent an APM cleaning. Thereafter, pure water (temperature: 25° C.) manufactured in the pure water manufacturing apparatus 10 and having a dissolved gas concentration of 0.4 ppm was used as it was to perform a pure water rinsing on the semiconductor substrate that had undergone the APM cleaning.

### Reference Example 7

As in the method of Reference Example 1, pure water (dissolved gas concentration: 0.4 ppm) adjusted to have a temperature of 40° C. was used to perform a hot water rinsing on a semiconductor substrate having a silicon nitride film formed thereon.

### Reference Example 8

As in the method of Example 1, pure water (temperature: 25° C.) adjusted to have a dissolved nitrogen concentration of 16 ppm was used without being heated to perform a pure water rinsing on a semiconductor substrate having a silicon nitride film formed thereon.

### Reference Example 9

Pure water (temperature: 25° C.) manufactured in the pure water manufacturing apparatus 10 and having a dissolved gas concentration of 0.4 ppm was used as it was to perform a pure water rinsing on a semiconductor substrate having a silicon nitride film formed thereon.

The results of the cleaning are shown in Tables 1 to 3.

TABLE 1

| | | dissolved gas | | | |
|---|---|---|---|---|---|
| | cleaning | concentration | temperature | semiconductor | particle |
| Ex. | liquid | (ppm) | (° C.) | substrate | generation |
| 1 | pure | 4 (N₂) | 40 | after | none |
| 2 | water | 16 (N₂) | 40 | SPM | none |
| 3 | | 4 (N₂) | 70 | cleaning | none |
| 4 | | 16 (N₂) | 70 | | none |
| 5 | | 20 (N₂) | 70 | | none |
| 6 | | 4 (N₂) | 70 | after | none |
| 7 | | 16 (N₂) | 70 | APM | none |
| 8 | | 20 (N₂) | 70 | cleaning | none |
| 9 | | 4 (N₂) | 70 | — | none |
| 10 | | 16 (N₂) | 70 | | none |
| 11 | | 20 (N₂) | 70 | | none |

TABLE 2

| | | | dissolved gas | | | |
|---|---|---|---|---|---|---|
| | cleaning | hydrofluoric acid:pure | concentration | temperature | semiconductor | particle |
| Ex. | liquid | water | (ppm) | (° C.) | substrate | generation |
| 12 | diluted | 1:100 | 0.4 | 25 | after | none |
| 13 | hydrofluoric | 1:500 | 0.4 | 25 | SPM | none |
| 14 | acid | 1:100 | 4 (N₂) | 25 | cleaning | none |
| 15 | | 1:500 | 16 (N₂) | 25 | | none |
| 16 | | 1:100 | 0.4 | 25 | after | none |
| 17 | | 1:500 | 0.4 | 25 | APM | none |
| 18 | | 1:100 | 4 (N₂) | 25 | cleaning | none |
| 19 | | 1:500 | 16 (N₂) | 25 | | none |
| 20 | | 1:100 | 0.4 | 25 | — | none |
| 21 | | 1:500 | 0.4 | 25 | | none |
| 22 | | 1:100 | 4 (N₂) | 25 | | none |
| 23 | | 1:500 | 16 (N₂) | 25 | | none |

TABLE 3

| | | dissolved gas | | semi- | |
|---|---|---|---|---|---|
| Ref | cleaning | concentration | temperature | conductor | particle |
| Ex. | liquid | (ppm) | (° C.) | substrate | generation |
| 1 | pure | 0.4 | 40 | after | present |
| 2 | water | 16 (N₂) | 25 | SPM | none |
| 3 | | 0.4 | 25 | cleaning | none |
| 4 | | 0.4 | 40 | after | present |
| 5 | | 16 (N₂) | 25 | APM | none |
| 6 | | 0.4 | 25 | cleaning | none |
| 7 | | 0.4 | 40 | — | present |
| 8 | | 16 (N₂) | 25 | | none |
| 9 | | 0.4 | 25 | | none |

Particle generation after the cleaning was measured using a stereoscopic microscope, and judged as “none” when particles that affected a semiconductor element formed on the substrate was not detected, while judged as “present” when such particles were detected.

In Examples 1 to 8 where the pure water having the dissolved gas concentration of 4 to 20 ppm was used for the hot water rinsing on the semiconductor substrate that had undergone the SPM cleaning or the APM cleaning, no particle was generated. In Examples 9 to 11 where the pure water having the dissolved gas concentration of 4 to 20 ppm was used for the hot water rinsing on the semiconductor substrate having a silicon nitride film formed thereon, no particle was generated.

In Examples 12 to 19 where the diluted hydrofluoric acid was used for the cleaning on the semiconductor substrate that had undergone the SPM cleaning or the APM cleaning and the pure water was used for the rinsing on the resultant semiconductor substrate, no particle was generated. In Examples 20 to 23 where the diluted hydrofluoric acid was used for the cleaning on the semiconductor substrate having a silicon nitride film formed thereon and the pure water was used for the rinsing on the resultant semiconductor substrate, no particle was generated.

In Reference Example 1 where the pure water having the dissolved gas concentration of 0.4 ppm and the temperature of 40° C. was used for the rinsing on the semiconductor substrate that had undergone the SPM cleaning, particles were generated. In Reference Examples 2 and 3 where the pure water having the dissolved gas concentration of 0.4 ppm and 16 ppm and the temperature of 25° C. was used for the rinsing on the semiconductor substrate that had undergone the SPM cleaning, no particle was generated.

In Reference Example 4 where the pure water having the dissolved gas concentration of 0.4 ppm and the temperature of 40° C. was used for the rinsing on the semiconductor substrate that had undergone the APM cleaning, particles were generated. In Reference Examples 5 and 6 where the pure water having the dissolved gas concentration of 0.4 ppm and 16 ppm and the temperature of 25° C. was used for the rinsing on the semiconductor substrate that had undergone the APM cleaning, no particle was generated.

In Reference Example 7 where the pure water having the dissolved gas concentration of 0.4 ppm and the temperature of 40° C. was used for the rinsing on the semiconductor substrate having a silicon nitride film formed thereon, particles were generated. In Reference Examples 8 and 9 where the pure water having the dissolved gas concentration of 0.4 ppm and 16 ppm and the temperature of 25° C. was used for the rinsing on the semiconductor substrate having a silicon nitride film formed thereon, no particle was generated.

In general, since the SPM cleaning and the APM cleaning are successively performed in many processes, the rinsing temperature is preferably not changed for each preceding cleaning process, and the hot water rinsing is preferably applied throughout the entire process.

What is claimed is:

1. A pure water supply system, comprising:
a pure water manufacturing means for manufacturing pure water having a dissolved gas concentration of 0.4 ppm or lower;
a first pure water supply means capable of supplying the pure water from the pure water manufacturing means;
a dissolving means that is coupled to the pure water manufacturing means via a coupling portion and dissolves gas in the pure water transferred from the pure water manufacturing means via the coupling portion; and
a second pure water supply means capable of supplying the pure water in which the gas has been dissolved by the dissolving means.

2. The pure water supply system according to claim 1, wherein the gas to be dissolved by the dissolving means is an inert gas or carbon dioxide.

3. The pure water supply system according to claim 1, further comprising a temperature adjusting means for adjusting the temperature of the pure water supplied from the second pure water supply means.

4. The pure water supply system according to claim 3, wherein the temperature adjusting means is a heating means.

5. The pure water supply system according to claim 4, wherein the heating means is provided in any one of the coupling portion, the dissolving means and the second pure water supply means.

6. The pure water supply system according to claim 4, wherein the pure water supplied from the second pure water supply means has a temperature of 40 to 80° C. and a dissolved gas concentration of 4 to 20 ppm.

7. A cleaning system, comprising:
a pure water manufacturing means for manufacturing pure water having a dissolved gas concentration of 0.4 ppm or lower;
a first pure water supply means capable of supplying the pure water from the pure water manufacturing means;
a dissolving means that is coupled to the pure water manufacturing means via a coupling portion and dissolves gas in the pure water transferred from the pure water manufacturing means via the coupling portion;
a second pure water supply means capable of supplying the pure water in which the gas has been dissolved by the dissolving means; and
a cleaning means that is coupled to the first pure water supply means and/or the second pure water supply means and cleans a substrate using the pure water supplied from the first pure water supply means or the second pure water supply means.

8. The cleaning system according to claim 7, wherein the substrate is a substrate having a silicon nitride film or a silicon oxynitride film exposed thereon.

9. The cleaning system according to claim 7, wherein the gas to be dissolved by the dissolving means is an inert gas or carbon dioxide.

10. The cleaning system according to claim 7, further comprising a temperature adjusting means for adjusting the temperature of the pure water supplied from the second pure water supply means.

11. The cleaning system according to claim 10, wherein the temperature adjusting means is a heating means.

12. The cleaning system according to claim 11, wherein the heating means is provided in any one of the coupling portion, the dissolving means and the second pure water supply means.

13. The cleaning system according to claim 11, wherein the pure water supplied from the second pure water supply means has a temperature of 40 to 80° C. and a dissolved gas concentration of 4 to 20 ppm.

14. The cleaning system according to claim 13, wherein a substrate that has undergone SPM cleaning is cleaned with the pure water supplied from the second pure water supply means.

15. The cleaning system according to claim 7, wherein a substrate that has undergone APM cleaning is cleaned with the pure water supplied from the first pure water supply means or the second pure water supply means.

16. The cleaning system according to claim 7, further comprising a hydrofluoric acid mixing means for mixing hydrofluoric acid into the pure water supplied from the first pure water supply means and/or the second pure water supply means.

17. A method for cleaning a substrate, comprising the step of:
cleaning the substrate with the pure water supplied from the first pure water supply means or the second pure water supply means using the cleaning system according to claim 7.

18. A method for cleaning a substrate that has undergone SPM cleaning, comprising the step of:
cleaning the substrate with the pure water supplied from the second pure water supply means using the cleaning system according to claim 14.

19. A method for cleaning a substrate that has undergone APM cleaning, comprising the step of:
cleaning the substrate with the pure water supplied from the first pure water supply means or the second pure water supply means using the cleaning system according to claim 15.

20. A method for cleaning a substrate, comprising the step of:
cleaning the substrate with the pure water mixed with hydrofluoric acid that is supplied from the first pure water supply means or the second pure water supply means using the cleaning system according to claim 16.

21. The cleaning method according to claim 20, wherein the pure water mixed with hydrofluoric acid is a mixture of 1 part by weight of 55 wt % hydrofluoric acid and 100 to 500 parts by weight of the pure water supplied from the first pure water supply means or the second pure water supply means.
